(19) United States
(12) Patent Application Publication
(10) Pub. No.: US 2026/0021768 A1
(43) Pub. Date: Jan. 22, 2026

(54) DISPLAY CONTROL DEVICE

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/172,978

(22) Filed: Apr. 8, 2025

(30) Foreign Application Priority Data
Jul. 19, 2024 (JP) 2024-116234

(51) Int. Cl. B60R 1/28; B60R 1/27; G06T 15/10; G07C 5/06

(52) U.S. Cl. CPC B60R 1/28; B60R 1/27; G06T 15/10; G07C 5/06; B60R 2300/302; B60R 2300/605; B60R 2300/607

(57) ABSTRACT

The display control device includes a control unit configured to display, on a display unit, a detection state of a vehicle image indicating the vehicle when viewed from a virtual viewpoint and a detection state of the surrounding information based on surrounding information of a vehicle surroundings detectable by the vehicle, and to change a display mode of the detection state when the vehicle is in a towing state in which the vehicle is towing a towed object.

### CROSS-REFERENCE TO RELATED APPLICATION

This application claims priority to Japanese Patent Application No. 2024-116234 filed on Jul. 19, 2024. The disclosure of the above-identified application, including the specification, drawings, and claims, is incorporated by reference herein in its entirety.

### BACKGROUND

### 1. Technical Field

The present disclosure relates to a display control device.

### 2. Description of Related Art

Japanese Patent No. 7048398 (JP 7048398 B) discloses a vehicle control device capable of performing autonomous driving that gives a sense of security to an occupant.

### SUMMARY

In the technology according to JP 7048398 B, an image indicating a host vehicle, an image indicating the surrounding situation of the host vehicle, and the like are displayed on a display unit (see FIG. 8 of JP 7048398 B). This technology does not have a viewpoint of changing the display mode of the display unit depending on whether the vehicle is towing a towed object. There is still room for improvement in the display method of the display unit in the towing state.

In view of the above, an object of the present disclosure is to provide a display control device that allows an occupant of a vehicle to grasp a change in a detection state of surrounding information on surroundings of the vehicle depending on the presence or absence of a towed object.

A display control device according to a first aspect of the present disclosure includes a control unit configured to cause a display unit to display, based on surrounding information on vehicle surroundings detectable by a vehicle, a vehicle image showing the vehicle that is viewed from a virtual viewpoint and a detection state of the surrounding information, and configured to change a display mode of the detection state when the vehicle is in a towing state in which the vehicle is towing a towed object.

In the display control device according to the first aspect of the present disclosure, the control unit causes the display unit to display, based on the surrounding information on the vehicle surroundings, the vehicle image and the detection state of the surrounding information. When the vehicle is in the towing state, the control unit changes the display mode of the detection state. Accordingly, the display control device allows the occupant of the vehicle to grasp the change in the detection state depending on the presence or absence of the towed object.

In the display control device according to the first aspect of the present disclosure, the control unit is configured to, when the vehicle is in the towing state, display a towed object image showing the towed object in connection with the vehicle image.

In the display control device according to the first aspect of the present disclosure, when the vehicle is in the towing state, the control unit displays the towed object image in connection with the vehicle image. Accordingly, the display control device allows the occupant to grasp the towed object that is being towed by the vehicle from the display contents on the display unit.

In the display control device according to the first aspect of the present disclosure, the control unit is configured to, when displaying the towed object image, shift a position of the vehicle image on the display unit in a traveling direction of the vehicle.

In the display control device according to the first aspect of the present disclosure, when displaying the towed object image, the control unit shifts the position of the vehicle image on the display unit in the traveling direction of the vehicle. Accordingly, the display control device can suppress a situation in which the towed object image is partially outside the screen as compared with a configuration in which the position of the vehicle image is not adjusted when displaying the towed object image.

In the display control device according to the first aspect of the present disclosure, the control unit is configured to, when the vehicle is in the towing state, cause the display unit to display information indicating that a specific driving assist function is not executed.

In the display control device according to the first aspect of the present disclosure, when the vehicle is in the towing state, the control unit causes the display unit to display the information indicating that the specific driving assist function is not executed. Accordingly, the display control device allows the occupant to grasp that the specific driving assist function is not executed in the towing state from the display contents on the display unit.

In the display control device according to the first aspect of the present disclosure, the control unit is configured to, when the vehicle is in the towing state, cause the display unit to display information indicating that acceleration performance of the vehicle has changed.

In the display control device according to the first aspect of the present disclosure, when the vehicle is in the towing state, the control unit causes the display unit to display the information indicating that the acceleration performance of the vehicle has changed. Accordingly, the display control device allows the occupant to grasp that the acceleration performance of the vehicle has changed in the towing state from the display contents on the display unit.

As described above, the display control device according to the present disclosure allows the occupant of the vehicle to grasp the change in the detection state of the surrounding information on the surroundings of the vehicle depending on the presence or absence of the towed object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle;

FIG. 2 is a flowchart illustrating a flow of a specific process;

FIG. 3 is a first display example displayed on a monitor;

FIG. 4 is a second display example displayed on a monitor;

FIG. 5 is a third exemplary display displayed on a monitor; and

FIG. 6 is a fourth display example displayed on the monitor.

### DETAILED DESCRIPTION OF EMBODIMENTS

Hereinafter, the vehicle 10 according to the present embodiment will be described.

### First Embodiment

First, the vehicle 10 according to the first embodiment of the present disclosure will be described.

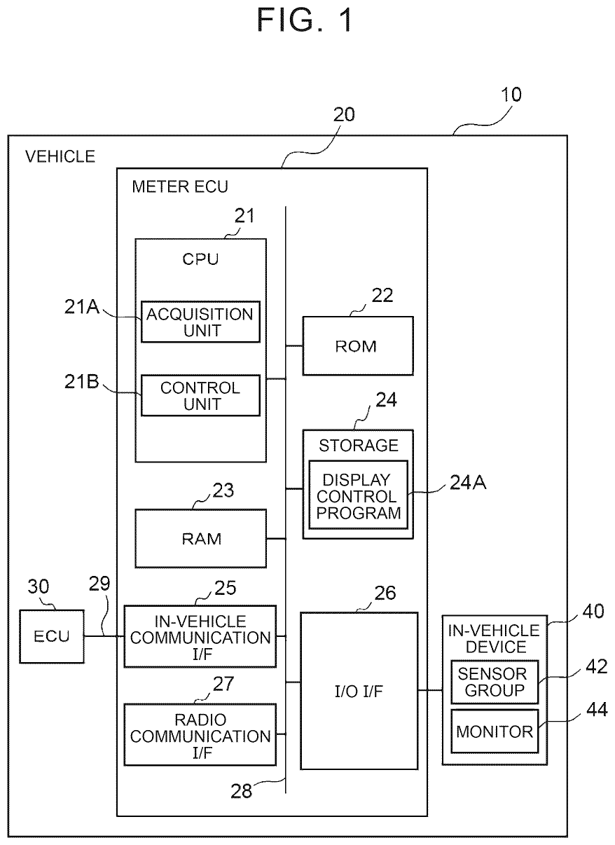

FIG. 1 is a block diagram illustrating a hardware configuration of a vehicle 10. As illustrated in FIG. 1, the vehicles 10 include a meter ECU (Electronic Control Unit) 20. The vehicle 10 is an example of a “vehicle” of the present disclosure, and the meter ECU 20 is an example of a “display control device” of the present disclosure.

The meter ECU 20 includes CPU (Central Processing Unit) 21, ROM (Read Only Memory) 22, RAM (Random Access Memory) 23, storage 24, in-vehicle communication I/F (Inter Face) 25, input/output I/F 26, and radio communication I/F 27. CPU 21, ROM 22, RAM 23, the storage 24, the in-vehicle communication I/F 25, the input/output I/F 26, and the radio communication I/F 27 are communicably connected to each other via an inner bus 28.

CPU 21 is a central processing unit that executes various programs and controls each unit. That is, CPU 21 reads the program from ROM 22 or the storage 24, and executes the program using RAM 23 as a working area. CPU 21 performs control of the above-described configurations and various arithmetic processes in accordance with programs recorded in ROM 22 or the storage 24.

ROM 22 stores various programs and various data. RAM 23 temporarily stores a program/data as a working area.

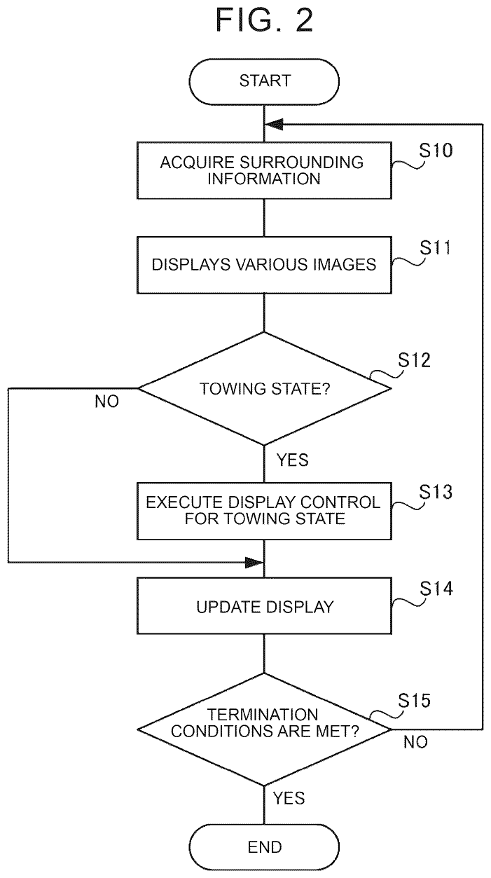

The storage 24 is constituted by a storage device such as an eMMC (embedded Multi-Media Card) or a UFS (Universal Flash Storage), and stores various programs and various data. The storage 24 stores a display-control-program 24A. The display control program 24A is a program for causing CPU 21 to execute a specifying process (see FIG. 2) to be described later.

The in-vehicle communication I/F 25 is an interface for connecting to another ECU 30. The interface uses a CAN protocol-based communication standard. The in-vehicle communication I/F 25 is connected to an external bus 29. Although not shown, a plurality of ECU are provided for each function of the vehicles 10 in addition to ECU 30.

The input/output I/F 26 is an interface for communicating with the in-vehicle device 40 mounted on the vehicle 10.

The in-vehicle device 40 is a variety of devices mounted on the vehicle 10. The vehicle 10 includes a sensor group 42 and a monitor 44 as an example of the in-vehicle device 40.

The sensor group 42 includes, for example, a 3D-LiDAR, a millimeter-wave sensor, an infrared sensor, a winker sensor, an accelerator position sensor, a vehicle speed sensor, a steering angle sensor, an angular velocity sensor, a GPS (Global Positioning System) sensor, an illuminance sensor, and a gyrosensor. Further, the sensor group 42 includes, as an example, a sensor for detecting a state of the vehicle 10, such as an acceleration sensor, and a state around the vehicle 10, a plurality of cameras for imaging the periphery of the vehicle 10, and the like. The sensor group 42 outputs a detection result of each sensor and an image captured by each camera to the meter ECU 20, ECU 30, and the like.

The monitor 44 is a meter display provided on a meter panel disposed in front of the driver's seat of the vehicle 10 and for displaying an operation proposal related to the function of the vehicle 10, an image related to the explanation of the function, and the like. The monitor 44 is an example of a “display unit” of the present disclosure. 20

The wireless communication I/F 27 is a wireless communication module for communicating with an external device. As the radio communication module, for example, communication standards such as 5G, LTE, Wi-Fi (registered trademark) and Bluetooth (registered trademark) are used.

Further, CPU 21 of the meter ECU 20 has, as a functional configuration, an acquiring unit 21A and a control unit 21B. The respective functional configurations are realized by CPU 21 reading and executing the display-control-program 24A stored in the storage 24.

The acquiring unit 21A acquires various types of data. For example, the acquiring unit 21A acquires, as various types of information, surrounding information around the vehicle 10 that can be detected by the vehicle 10. The surrounding information includes a detection result by each sensor constituting the sensor group 42, a captured image by each camera, and the like.

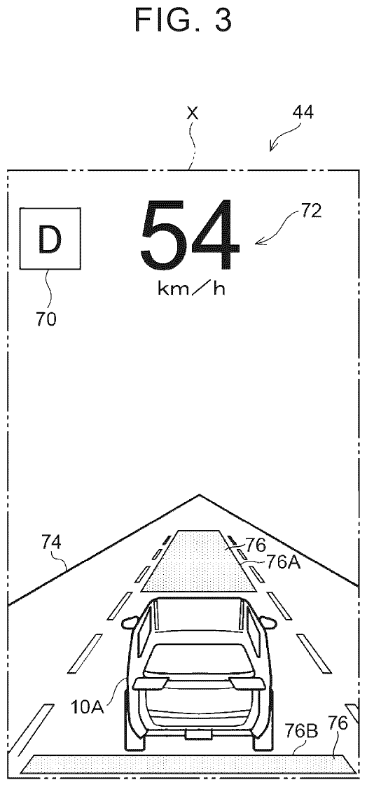

The control unit 21B performs display control related to the display of the monitor 44. For example, the control unit 21B causes the monitor 44 to display, as the display control, vehicle image 10A (see FIG. 3 and the like) indicating the vehicle 10 when viewed from the virtual viewpoint, based on the surrounding information acquired by the acquiring unit 21A. The virtual viewpoint is set on a three-dimensional virtual space whose origin is the position of the vehicle image 10A, and is defined by viewpoint coordinates and viewpoint angles (orientations) on the virtual space. For example, the virtual viewpoint is a viewpoint viewed at a specific viewpoint angle from a specific viewpoint coordinate on the upper side of the vehicle image 10A in the virtual space.

FIG. 2 is a flow chart illustrating a flow of a specifying process executed by the meter ECU 20. CPU 21 reads the display-control-program 24A from the storage 24, develops it in RAM 23, and executes it, thereby performing the specifying process. As an example, the identification processing is performed repeatedly and automatically every time a certain period of time elapses.

In S10 illustrated in FIG. 2, CPU 21 acquires surrounding information around the vehicles 10. Then, CPU 21 proceeds to S11.

In S11, CPU 21 displays various images on the monitor 44 based on the surrounding information acquired by S10. The various images include a vehicle image 10A, a road image 74 (see FIG. 3 and the like) indicating a road on which the vehicle 10 travels, and a range image 76 (see FIG. 3 and the like) indicating a detected state of surrounding information. Specific examples of the various images will be described later. Then, CPU 21 proceeds to S12.

In S12, CPU 21 determines whether or not the vehicle 10 is in a towing state that is towing the towed object. Examples of the towed object include a camping trailer, a boat trailer, and a bike trailer. Here, when it is determined that CPU 21 is in the towing state (S12: YES), the process proceeds to S13. On the other hand, when it is determined that CPU 21 is not in the towing state (S12: NO), the process proceeds to S14. As an example, CPU 21 determines that the vehicle 10 is in a towing state when a predetermined button (not shown) of the in-vehicle device 40 is operated by a driver who is an occupant of the vehicle.

In S13, CPU 21 performs indication control for the towing state. A specific example of the display control will be described later. Then, CPU 21 proceeds to S14.

In S14, CPU 21 updates the content displayed on the monitor 44 based on the surrounding information acquired by S10. For example, when the vehicle speed of the vehicle 10 increases or decreases, CPU 21 changes the numerical value shown in the vehicle speed information 72 (see FIG. 3 and the like) to be described later displayed on the monitor 44. In addition, when the vehicle 10 approaches another vehicle, CPU 21 narrows the inter-vehicle distance between the vehicle image 10A on the monitor 44 and the image indicating the other vehicle. Then, CPU 21 proceeds to S15.

In S15, CPU 21 determines whether a predetermined termination condition is satisfied. Here, when CPU 21 determines that the termination condition is satisfied (S15: YES), the specifying process is terminated. On the other hand, when it is determined that the termination condition is not satisfied (S15: NO), CPU 21 returns to S10. As an example, CPU 21 determines that the termination condition is satisfied when the ignition switch of the vehicle 10 is turned off.

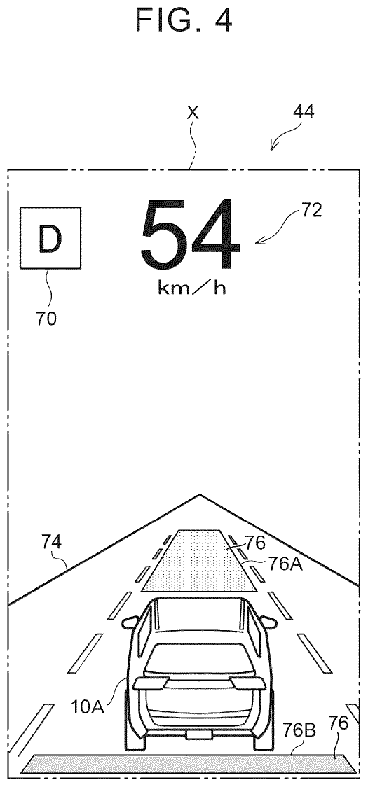

Next, a display example of the monitor 44 will be described with reference to FIGS. 3 and 4.

FIG. 3 is a first explanatory diagram illustrating a display example displayed in the display area X of the monitor 44. The display area X is a partial area of the monitor 44, and is visible through an opening of the steering wheel by a driver seated in the driver's seat. As an example, FIG. 3 shows the display contents when the vehicle 10 is not in the towing state.

The shift information 70 and the vehicle speed information 72 are displayed in an upper portion of the display area X illustrated in FIG. 3.

The shift information 70 indicates a shift position of the vehicle 10. In FIG. 3, “D” is displayed as the shift information 70, indicating that the shift position is in the D range.

The vehicle speed information 72 indicates the vehicle speed of the vehicle 10. In FIG. 3, “54 km/h” is displayed as the vehicle speed information 72, indicating that the vehicle speed is 54 km/h.

In the display area X shown in FIG. 3, a road image 74 is displayed under the shift information 70 and the vehicle speed information 72. The road image 74 is an image showing a road around the vehicle 10 shown in the map data stored in the external server, the storage 24, or the like.

In FIG. 3, the vehicle image 10A and the range image 76 are displayed on the road image 74.

The vehicle image 10A is an image generated based on the illustration design of the vehicle 10 shown in the illustration data stored in the storage 24. As an example, the vehicle 10 travels in a central lane of a road of three lanes on one side. Therefore, in FIG. 3, the vehicle image 10A is displayed in the center lane of the road shown in the road image 74 from the viewpoint viewed from the virtual viewpoint.

The range image 76 is a graphic image indicating a detection state of the surrounding information. As an example, the range image 76 includes a front range image 76A indicating a detection state of the surrounding information on the front side of the vehicle 10 in the same lane as the vehicle 10, and a rear range image 76B indicating a detection state of the surrounding information on the rear side of the vehicle 10 in the same lane.

The front range image 76A is displayed on the upper side in the drawing of the vehicle image 10A corresponding to the front side of the vehicle 10. As an example, the front range image 76A has a trapezoidal shape and is dot-patterned in the trapezoidal shape.

The rear range image 76B is displayed on the lower side in the drawing of the vehicle image 10A corresponding to the rear side of the vehicle 10. As an example, the rear range image 76B is trapezoidal and has the same dot-pattern as the front range image 76A in the trapezoid.

FIG. 4 is a second explanatory diagram illustrating a display example displayed in the display area X of the monitor 44. As an example, FIG. 4 shows display contents when the vehicle 10 is in a towing state.

In the display area X shown in FIG. 4, the vehicle image 10A, the shift information 70, the vehicle speed information 72, the road image 74, the front range image 76A, and the rear range image 76B are displayed. Note that, among the above-described respective pieces of information, a display mode other than the rear-range image 76B is the same as that of FIG. 3, and thus the description thereof is omitted.

Here, as the display control for the towing state in S13, CPU 21 changes the display mode of the rear-range image 76B in the towing state from the case where the rear-range image is not in the towing state. For example, in the rear range image 76B shown in FIG. 4, unlike FIG. 3 in which a dot-pattern is applied in a trapezoid, the inside of the trapezoid is colored gray.

Here, the range image 76 is provided with a plurality of display modes corresponding to the detection status of the surrounding information. In the present embodiment, as the plurality of display modes, a normal mode indicating that the detection state is a normal state and a special mode indicating that the detection state is a special state are provided. In general, the front range image 76A and the rear range image 76B in FIG. 3 and the front range image 76A in FIG. 4 are dotted in a trapezoidal shape. A particular aspect is an aspect in which the inside of the trapezoid shown in the rear range image 76B of FIG. 4 is colored gray.

As described above, in the meter ECU 20, CPU 21 causes the monitor 44 to display the range image 76 indicating the detected state of the vehicle image 10A and the surrounding information based on the surrounding information on the surroundings of the vehicle 10. Then, CPU 21 changes the mode of displaying the range images 76 when the vehicles 10 are in the towing state. In the exemplary embodiment illustrated in FIG. 4, CPU 21 changes the display mode of the rear range image 76B indicating the detection status of the rear side of the vehicle 10 from the normal mode to the special mode.

Here, when the vehicle 10 is in the towing state, the detection range of the sensor that detects the surrounding information behind the vehicle 10 included in the sensor group 42 is narrowed due to the presence of the towed object connected to the rear of the vehicle 10. In addition, when the vehicle 10 is in the towing state, the towed object appears in the captured image of the camera that captures an image of the rear of the vehicle 10 included in the sensor group 42, so that the range behind the vehicle 10 that can be recognized based on the captured image is narrowed. Therefore, in the present embodiment, when the vehicle 10 is in the towing state, the driver is notified that the detection range or the like of the sensor is narrowed by changing the display mode of the rear range image 76B indicating the detection state of the surrounding information on the rear side of the vehicle 10. With the above-described configuration, the meter ECU 20 allows the driver of the vehicle 10 to grasp the change in the detection status of the surrounding information according to the presence or absence of the towed object.

### Second Embodiment

Next, a description will be given of the vehicle 10 according to the second embodiment of the present disclosure while omitting or simplifying a portion overlapping with the above-described embodiment.

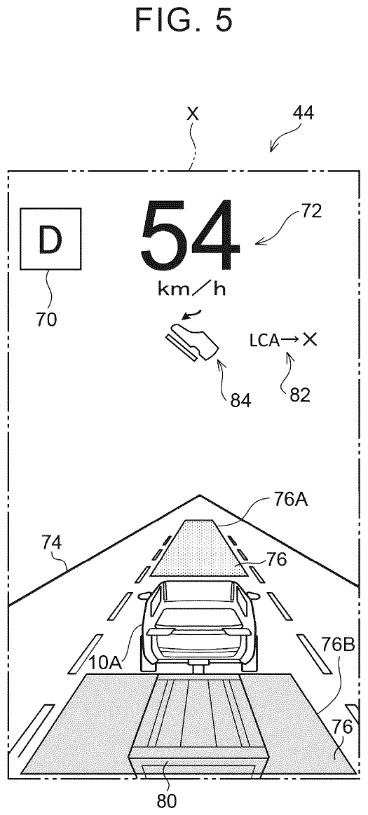

FIG. 5 is a third explanatory diagram illustrating a display example displayed in the display area X of the monitor 44. As an example, FIG. 5 shows a display content when the vehicle 10 is towing the camping trailer as a towed object.

In the display area X shown in FIG. 5, in addition to the respective pieces of information shown in FIG. 4, a towed object image 80, caution information 82, and acceleration performance information 84 are displayed. In this case, CPU 21 causes the monitor 44 to display the towed object image 80, the caution information 82, and the acceleration performance information 84 as the display control for the towing state in S13, and changes the display mode of the rear-range image 76B from the normal mode to the special mode.

The towed object image 80 is an image generated based on the illustration design of the camping trailer shown in the illustration data stored in the storage 24. CPU 21 specifies the type of the towed object from the captured images of the cameras that capture the rear of the vehicles 10 included in the sensor group 42, and draws an illustration design corresponding to the specified towed object in the illustration data on the monitor 44.

When the towed object image 80 is displayed, CPU 21 shifts the arrangement of the vehicle image 10A on the monitor 44 by the display area of the towed object image 80 toward the traveling direction of the vehicle 10. For example, CPU 21 directly or indirectly shifts the arrangement of the vehicle image 10A by changing the coordinates of the vehicle image 10A in the three-dimensional virtual space or changing the viewpoint angle (orientation) on the virtual space. Accordingly, the vehicle image 10A illustrated in FIG. 5 is disposed above the display area X as compared with the vehicle image 10A illustrated in FIG. 3.

The caution information 82 is information indicating that the specific driving support function is not executed. In the present embodiment, a particular driving assistance function is LCA (Lane Change Assist). Therefore, in FIG. 5, “LCA→x” is displayed as the caution information 82, indicating that LCA is not executed when the vehicles 10 are in the towing state.

The acceleration performance information 84 is information indicating that the acceleration performance of the vehicle 10 has changed. When the vehicle 10 is in the towing state, the acceleration performance is deteriorated because the vehicle 10 travels while towing the towed object, and therefore, it is necessary to increase the accelerator operation amount as compared with the case where the vehicle is not in the towing state. Therefore, in FIG. 5, an icon for instructing depression of the accelerator pedal is displayed as the acceleration performance information 84, and when the vehicle 10 is in a towing state, it is necessary to increase the accelerator operation amount because the acceleration performance of the vehicle 10 has changed.

In FIG. 5, a towed object image 80 showing a camping trailer as a towed object is illustrated. However, when CPU 21 identifies a different type of towed object from the captured image of the camera, an image indicating a different type of towed object is displayed in the display area X.

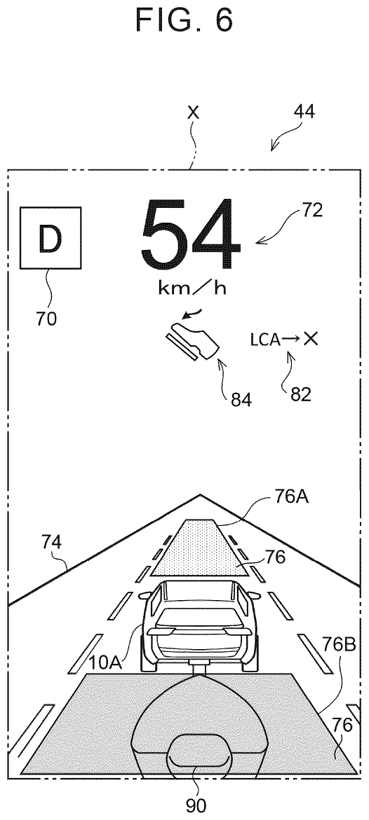

FIG. 6 is a fourth explanatory diagram illustrating a display example displayed in the display area X of the monitor 44. As an example, FIG. 6 shows a display content when the vehicle 10 is towing a boat trailer as a towed object.

In the display area X shown in FIG. 6, the vehicle image 10A, the shift information 70, the vehicle speed information 72, the road image 74, the front range image 76A, the rear range image 76B, the caution information 82, the acceleration performance information 84, and the towed object image 90 are displayed. Note that, among the respective pieces of information described above, the display modes other than the towed object image 90 are the same as those in FIG. 5, and thus description thereof will be omitted.

The towed object image 90 is an image generated based on the illustration design of the boat trailer shown in the illustration data stored in the storage 24. CPU 21 identifies the type of the towed object as the boat trailer from the captured images of the cameras, and draws an illustration design corresponding to the boat trailer in the illustration data on the monitor 44.

As described above, in the meter ECU 20, as a function of the control unit 21B, when the vehicle 10 is in the towing state, CPU 21 connects the towed object images 80 and 90 to the vehicle image 10A and displays them. Accordingly, in the meter ECU 20, the driver can be made to recognize the towed object that is being towed by the vehicles 10 from the displayed content of the monitor 44.

In the meter ECU 20, when the towed object images 80 and 90 are displayed as the function of the control unit 21B, CPU 21 shifts the arrangement of the vehicle image 10A on the monitor 44 toward the traveling direction of the vehicle 10. Accordingly, in the meter ECU 20, it is possible to suppress a situation in which the towed object images 80 and 90 are cut off as compared with a configuration in which the arrangement of the vehicle image 10A is not adjusted when the towed object images 80 and 90 are displayed.

In the meter ECU 20, CPU 21 causes the monitor 44 to display, as a function of the control unit 21B, caution information 82 indicating that LCA is not executed as a particular driving assistance function when the vehicle 10 is in the towing state. Thus, in the meter ECU 20, it is possible to allow the driver to recognize that LCA is not executed in the towing state from the displayed content of the monitor 44.

In the meter ECU 20, CPU 21 displays, as a function of the control unit 21B, the acceleration performance information 84 indicating that the acceleration performance of the vehicle 10 has changed when the vehicle 10 is in the towing state on the monitor 44.

Thus, in the meter ECU 20, it is possible to allow the driver to recognize that the acceleration performance of the vehicles 10 has changed in the towing state from the displayed content of the monitor 44.

### Others

Although the embodiments of the present disclosure have been described in detail with reference to the accompanying drawings, the technical scope of the present disclosure is not limited to such examples. It will be apparent to those skilled in the art that various modifications and variations can be made within the scope of the technical idea described in the claims. In other words, it is to be understood that these modifications and examples of modification fall within the technical scope of the disclosure.

Further, the effects described in the above embodiments are illustrative or exemplary, and are not limited to those described in the above embodiments. That is, the technology according to the present disclosure can produce other effects that are obvious to a person having ordinary knowledge in the technical field of the present disclosure from the description in the above embodiment, together with the effects described in the above embodiment or instead of the effects described in the above embodiment.

The processing described in the above embodiment can also be realized by a dedicated hardware circuit. In this case, it may be executed by one piece of hardware or by a plurality of pieces of hardware.

In the above-described embodiment, the display-control-program 24A is stored in the storage 24. However, the present disclosure is not limited thereto, and the display control program 24A may be stored in ROM 22.

In the above embodiment, as an example of changing the display mode of the detection status of the surrounding information, in the first embodiment, the display mode of the rear range image 76B is changed, and in the second embodiment, the display mode of the rear range image 76B is changed, and the towed object images 80 and 90 are additionally displayed. However, the present disclosure is not limited thereto, and only the towed object images 80 and 90 may be displayed without changing the display mode of the rear-range image 76B in the towing state.

In the above-described embodiment, the display mode of the detection state of the surrounding information is changed uniformly in the case of the towing state regardless of the type of the towed object, but the present disclosure is not limited thereto. For example, in a case where the towed object is of a type having a narrow vehicle width such as a bike trailer, the display mode of the detection state may not be changed even in the towing state. Similarly, if the towed object is of a narrow type, the execution of the specific driving assistance function may not be restricted even in the towing state. In addition, when a sensor capable of detecting information around a towed object is mounted on the towed object, the vehicle 10 acquires a detection result of the sensor. Thus, the display mode of the detection state does not need to be changed even in the towing state, and the execution of the specific driving support function does not need to be restricted.

The display mode of the information indicating that the specific driving assistance function is not executed when the vehicle 10 is in the towing state is not limited to the display mode indicated by the caution information 82. For example, the content of the information may be indicated directly by characters, such as “LCA cannot be used”.

The display mode of the information indicating that the acceleration performance of the vehicle 10 has changed when the vehicle 10 is in the towing state is not limited to that indicated by the acceleration performance information 84. For example, the rear of the vehicle body of the vehicle image 10A may be submerged, or a sweat mark, an exclamation point, or the like indicating sweat may be displayed around the vehicle image 10A.

The general and special aspects of the range image 76 are not limited to the aspects illustrated in the above embodiments. It is needless to say that patterns, coloring, and the like different from those of the above-described embodiment are applied as the normal mode or the special mode.

In the above-described embodiment, when the vehicle 10 is in the towing state, CPU 21 may display assistance information for assisting the driving operation of the vehicle 10 in the towing state on the monitor 44. CPU 21 may display, for example, an operation timing and an operation amount of the steering wheel at the time of the curve, a captured image of the rear side of the vehicle 10 at the time of the curve, an overhead image of the vehicle 10, and the like as the assistance information. Accordingly, it is possible to support the driving operation of the vehicle 10 in the towing state in which the difficulty level of the driving operation at the time of the curve is increased as compared with the case where the vehicle is not in the towing state.

In the above-described embodiment, CPU 21 may adjust at least one of the operation strength and the operation timing of the predetermined driving assistance function when the vehicle 10 is in the towing state. For example, when the vehicle 10 is in the towing state, CPU 21 may increase the accelerator operation amount more than when the vehicle is not in the towing state during the execution of ACC (Adaptive Cruise Control) as the predetermined driving support function. Also, in the same scenario, CPU 21 may adjust the actuation strength to reduce braking force. In addition, CPU 21 may reduce the braking force when executing PCS (Pre-Collision System) as a predetermined driving assistance function when the vehicles 10 are in the towing state, as compared with the case where the vehicles are not in the towing state. At the same time, CPU 21 may adjust the actuation strength and the actuation timing to accelerate the braking actuation initiation timing.

In the above-described embodiment, the display portions of the towed object images 80 and 90 in the display area X of the monitor 44 are not particularly limited. For example, as in the above-described embodiment, the towed object images 80 and 90 may be displayed in the display area X so that the entire image of the camping trailer or the boat trailer that is the towed object can be grasped. In addition, in the towed object images 80 and 90, only a portion of a camping trailer or a boat trailer that is a towed object may be displayed in the display area X.

In the above-described embodiment, when the towed object images 80 and 90 are displayed, CPU 21 shifts the arrangement of the vehicle image 10A on the monitor 44 toward the traveling direction of the vehicle 10 by the display area of the towed object images 80 and 90. However, the present disclosure is not limited to this, and in the above-described cases, CPU 21 may shift the arrangement of the vehicle image 10A on the monitor 44 by more than the display area of the towed object images 80 and 90 toward the traveling direction of the vehicle 10. In this case, a space is generated on the lower side of the towed object images 80 and 90 in the monitor 44.

In the above embodiment, the monitor 44, which is a meter display, is an example of the “display unit” of the present disclosure, but the example of the “display unit” is not limited to the meter display. For example, an exemplary “display unit” may be other displays, such as a center display and a head-up display (HUD). An example of the “display unit” may be a combination of a plurality of displays such as a meter display and a center display.

In the above-described embodiment, the meter ECU 20 executes the specifying process illustrated in FIG. 2. However, the present disclosure is not limited thereto, and the specifying process may be executed by the meter ECU 20 and other ECU in cooperation with each other.

It should be noted that the identifying process executed by CPU 21 reading the software (program) in the above-described embodiment may be executed by various processors other than CPU. Examples of the processor include a PLD (Programmable Logic Device) in which a circuit configuration can be changed after manufacturing of FPGA (Field-Programmable Gate Array), and the like, and a dedicated electric circuit that is a processor having a circuit configuration designed exclusively for executing a particular process such as ASIC (Application Specific Integrated Circuit), and the like. Further, the specifying process may be executed by one of these various processors, or may be executed by a combination of two or more processors (for example, a plurality of FPGA, a combination of CPU and FPGA, and the like) of the same type or different types. Further, a hardware structure of the various processors is, more specifically, an electric circuit in which circuit elements such as semiconductor elements are combined.

In the above embodiment, the display control program 24A is stored (installed) in the storage 24 in advance, but the present disclosure is not limited thereto. The display-control-program 24A may be provided in a form recorded in a recording medium such as CD-ROM (Compact Disk Read Only Memory), DVD-ROM (Digital Versatile Disk Read Only Memory), and USB (Universal Serial Bus). In addition, the display-control-program 24A may be downloaded from an external device via a network. Note that the technology of the present disclosure can also be applied to programs and program products.

What is claimed is:

1. A display control device comprising a control unit configured to cause a display unit to display, based on surrounding information on vehicle surroundings detectable by a vehicle, a vehicle image showing the vehicle that is viewed from a virtual viewpoint and a detection state of the surrounding information, and configured to change a display mode of the detection state when the vehicle is in a towing state in which the vehicle is towing a towed object.

2. The display control device according to claim 1, wherein the control unit is configured to, when the vehicle is in the towing state, display a towed object image showing the towed object in connection with the vehicle image.

3. The display control device according to claim 2, wherein the control unit is configured to, when displaying the towed object image, shift a position of the vehicle image on the display unit in a traveling direction of the vehicle.

4. The display control device according to claim 1, wherein the control unit is configured to, when the vehicle is in the towing state, cause the display unit to display information indicating that a specific driving assist function is not executed.

5. The display control device according to claim 1, wherein the control unit is configured to, when the vehicle is in the towing state, cause the display unit to display information indicating that acceleration performance of the vehicle has changed.
